(19) United States
(12) Patent Application Publication
(10) Pub. No.: US 2010/0192587 A1
(43) Pub. Date: Aug. 5, 2010

(54) COMBUSTOR ASSEMBLY FOR USE IN A GAS TURBINE ENGINE AND METHOD OF ASSEMBLING SAME

(76) Inventors: William Kirk Hessler, Greer, SC (US); Derrick Walter Simons, Greer, SC (US); Jeffrey Scott Lebegue, Simpsonville, SC (US)

Correspondence Address: JOHN S. BEULICK (17851);ARMSTRONG TEASDALE LLP, ONE METROPOLITAN SQUARE, SUITE 2600, ST. LOUIS, MO, 63102-2740, US

(21) Appl. No.: 12/364,924

(22) Filed: Feb. 3, 2009

(51) Int. Cl. F23R 3/42; B23P 11/00

(52) U.S. Cl. 60/752; 29/889.2

(57) ABSTRACT

A combustor assembly for use in a gas turbine engine and method of assembly is described. The combustor assembly includes a combustor liner having a slot that at least partially circumscribes the combustor liner. The slot is defined adjacent to a venturi throat region defined within the liner. The combustor assembly also includes a restrictor plate having at least one aperture defined therein. The restrictor plate is removably coupled within the combustor assembly such that the restrictor plate is inserted within the slot and extends at least partially across the venturi throat region.

### BACKGROUND OF THE INVENTION

This invention relates generally to combustion systems for use with gas turbine engines and, more particularly, to a venturi throat region defined in a gas turbine engine combustion system.

At least some known gas turbine engines include combustor assemblies that include plurality of fuel nozzle assemblies that direct fuel into a combustion zone defined in the combustor assemblies. Some known combustor assemblies include a primary combustion zone and a secondary combustion zone that are separated by a venturi throat region. The venturi throat region is used to fluid-dynamically separate the primary and secondary combustion zones and to optimize flow characteristics within the combustor assembly.

To facilitate optimizing the operation of at least some known combustor assemblies the location and size of the venturi throat region are variably adjusted. However, adjusting the location and size of at least some venturi throat regions may be expensive, and/or time consuming. Moreover, generally to perform such adjustments the gas turbine engine is removed from operation for extended time periods and may require complex manufacturing processes to fabricate components used in the venturi throat region.

### BRIEF DESCRIPTION OF THE INVENTION

In one aspect, a method assembling a combustor assembly is described. The method including coupling a combustor liner within a gas turbine engine such that a primary combustion zone and a secondary combustion zone are defined. The combustor liner includes a slot at least partially circumscribing the combustor liner and defined therein. The slot is positioned adjacent to a venturi throat region defined between the primary and the secondary combustion zones. The method also includes inserting, within the slot, a restrictor plate including at least one aperture defined therein. The method further includes coupling the restrictor plate within the combustor liner such that the restrictor plate extends at least partially across the venturi throat region to limit flow from the primary combustion zone to the secondary combustion zone.

In another aspect, a combustor assembly for use in a gas turbine engine is described. The combustor assembly includes a combustor liner having a slot that at least partially circumscribes the combustor liner. The slot is defined adjacent to a venturi throat region defined within the liner. The combustor assembly also includes a restrictor plate having at least one aperture defined therein. The restrictor plate is removably coupled within the combustor assembly such that the restrictor plate is inserted within the slot and extends at least partially across the venturi throat region.

In another aspect, a gas turbine engine is described. The gas turbine engine includes a compressor and a combustor assembly. The combustor assembly is coupled downstream from the compressor. The combustor assembly includes a combustor liner having a slot that at least partially circumscribes the combustor liner. The slot is defined adjacent to a venturi throat region defined within the combustor liner. The combustor assembly also includes a restrictor plate having at least one aperture defined therein. The restrictor plate removably coupled within the combustor liner slot such that the restrictor plate extends at least partially across the venturi throat region.

### BRIEF DESCRIPTION OF THE DRAWINGS

FIG. 1 is partial cross-sectional view of an exemplary gas turbine combustor assembly;

FIG. 2 is a partial perspective view of the gas turbine combustor assembly shown in FIG. 1;

FIG. 3 is a partial perspective cross-sectional view of an exemplary venturi throat region used with the gas turbine combustor assembly shown in FIG. 2;

FIG. 4 is a partial perspective cross-sectional view of the venturi throat region including a restrictor plate;

FIG. 5 is a partial perspective cross-sectional view of the venturi throat region shown in FIG. 3 and including an alternative restrictor plate;

FIG. 6A is a plan view of yet another alternate restrictor plate that may be used within the venture throat region shown in FIG. 3;

FIG. 6B is a plan view of a further alternative embodiment for the restrictor plate that may be used within the venture throat region shown in FIG. 3; and

FIG. 6C is a plan view of yet another alternative restrictor plate that may be used within the venture throat region shown in FIG. 3.

### DETAILED DESCRIPTION OF THE INVENTION

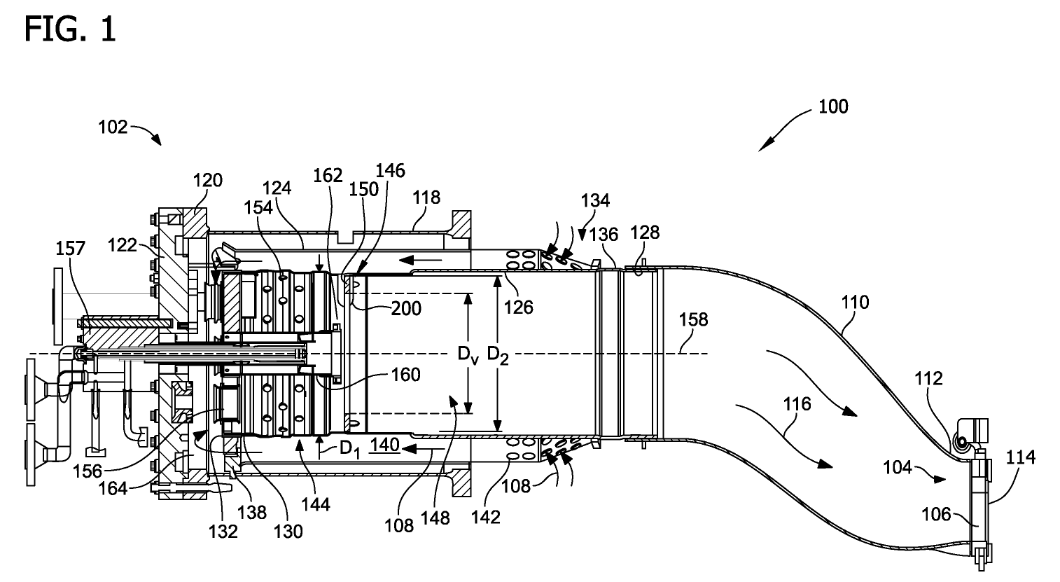

FIG. 1 is partial cross-sectional view of an exemplary combustor assembly 102 for use with a gas turbine engine 100 that includes a secondary fuel nozzle assembly 157. Gas turbine engine 100 also includes a compressor (not shown), and a turbine 104. Only a first stage nozzle 106 of turbine 104 is illustrated in FIG. 1. In the exemplary embodiment, turbine 104 is coupled to the compressor via a single common rotor shaft (not shown). The compressor pressurizes inlet air 108 entering engine 100 prior to it being channeled to combustor assembly 102 for use in the combustion process. In the exemplary embodiment, gas turbine engine 100 includes a plurality of combustor assemblies 102 that are spaced circumferentially within an engine casing (not shown). In one embodiment, combustor assembly 102 includes a plurality of can-annular combustors.

In the exemplary embodiment, gas turbine engine 100 includes a transition duct 110 that extends between an outlet end 112 of combustor assembly 102 and an inlet end 114 of turbine 104 to enable combustion gases 116 to be channeled downstream to turbine 104. Further, in the exemplary embodiment, combustor assembly 102 includes a substantially cylindrical combustor casing 118. Combustor casing 118 is coupled to the engine casing. More specifically, in the exemplary embodiment, a forward end 120 of combustor casing 118 is coupled to an end cover assembly 122. End cover assembly 122 includes supply tubes, manifolds, valves for channeling fuel, air and/or other fluids to combustor assembly 102, and/or any other components that enable gas turbine engine 100 to function as described herein.

In the exemplary embodiment, a substantially cylindrical flow sleeve 124 is coupled to combustor casing 118 such that flow sleeve 124 is substantially concentrically aligned with combustor casing 118. A combustor liner 126 is coupled substantially concentrically within flow sleeve 124. More specifically, combustor liner 126 is coupled at an aft end 128 to transition duct 110, and at a forward end 130 to a combustor liner cap assembly 132. Flow sleeve 124 is coupled at an aft end 134 to an outer wall 136 of combustor liner 126, and is coupled at a forward end 138 to combustor casing 118. Alternatively, flow sleeve 124 may be coupled to casing 118 and/or combustor liner 126 using any suitable coupling mechanism/assembly that enables gas turbine engine 100 to function as described herein. In the exemplary embodiment, an air passage 140 is defined between combustor liner 126 and flow sleeve 124. Flow sleeve 124 includes a plurality of apertures 142 defined therein that enable compressed air 108 from the compressor to enter air passage 140.

Combustor liner 126 defines a primary combustion zone 144, a venturi throat region 146, and a secondary combustion zone 148. More specifically, in the exemplary embodiment, primary combustion zone 144 is upstream from secondary combustion zone 148. Primary combustion zone 144 and secondary combustion zone 148 are separated by venturi throat region 146. In the exemplary embodiment, venturi throat region 146 has a smaller diameter Dᵥ than the diameters D₁ and D₂ of respective combustion zones 144 and 148. More specifically, throat region 146 includes a restrictor plate 150, described in more detail below, that defines diameter Dᵥ. Moreover, venturi throat region 146 functions as an aerodynamic separator or isolator that facilitates reducing flashback from secondary combustion zone 148 to primary combustion zone 144. In the exemplary embodiment, primary combustion zone 144 includes a plurality of apertures 154 defined therein that enable air 108 to enter primary combustion zone 144 from air passage 140.

Further, in the exemplary embodiment, combustor assembly 102 also includes a plurality of spark plugs (not shown) and a plurality of cross-fire tubes (not shown). The spark plugs and cross-fire tubes extend through ports (not shown) defined in combustor liner 126 within primary combustion zone 144 to enable fuel and air within each combustor assembly 102 to be ignited.

In the exemplary embodiment, at least one secondary fuel nozzle assembly 157 is coupled to end cover assembly 122. More specifically, in the exemplary embodiment, combustor assembly 102 includes one secondary fuel nozzle assembly 157 and a plurality of primary fuel nozzle assemblies 156. In the exemplary embodiment, primary fuel nozzle assemblies 156 are arranged in a generally circular array about a centerline 158 of combustor assembly 102. Alternatively, primary fuel nozzle assemblies 156 may be arranged in non-circular arrays. In an alternative embodiment, combustor assembly 102 may include more than one secondary fuel nozzle assembly 157. Although, only primary fuel nozzle assembly 156 and secondary fuel nozzle assembly 157 are described herein, alternatively, combustor assembly 102 may include other types of nozzle assemblies or fuel nozzles. In the exemplary embodiment, secondary fuel nozzle assembly 157 includes a tube assembly 160 that substantially encloses the portion of secondary fuel nozzle assembly 157 extending through primary combustion zone 144.

Primary fuel nozzle assemblies 156 extend partially into primary combustion zone 144, and secondary fuel nozzle assembly 157 extends through primary combustion zone into an aft portion 162 of throat region 146 that is adjacent to restrictor plate 150. As such, fuel (not shown) injected from primary fuel nozzle assemblies 156 is substantially combusted within primary combustion zone 144, and fuel (not shown) injected from secondary fuel nozzle assembly 157 is substantially combusted within secondary combustion zone 148.

In the exemplary embodiment, combustor assembly 102 is coupled to a fuel supply (not shown) for supplying fuel to combustor assembly 102 through fuel nozzle assemblies 156 and/or 157. For example, pilot fuel (not shown) and/or main fuel (not shown) may be supplied through fuel nozzle assemblies 156 and/or 157. In the exemplary embodiment, both pilot fuel and main fuel are supplied through both primary fuel nozzle assembly 156 and secondary fuel nozzle assembly 157 by controlling the flow of fuels to primary fuel nozzle assembly 156 and secondary fuel nozzle assembly 157. As used herein “pilot fuel” refers to fuel supplied to a pilot flame, and “main fuel” refers to fuel supplied to generate combustion gases 116 during non-start up operations. Fuel may be natural gas, petroleum products, coal, biomass, and/or any other fuel, in solid, liquid, and/or gaseous form that enables gas turbine engine 100 to function as described herein. By controlling fuel flows through fuel nozzle assemblies 156 and/or 157, a flame (not shown) within combustor assembly 102 may be adjusted to a pre-determined shape, length, and/or intensity to effect emissions and/or power output of combustor assembly 102.

In operation, air 108 enters gas turbine engine 100 through an engine inlet (not shown) and is compressed in the compressor. Compressed air 108 is discharged from the compressor towards combustor assembly 102. Air 108 enters combustor assembly 102 through apertures 142 and is channeled through air passage 140 towards end cover assembly 122. Air 108 flowing through air passage 140 is forced to reverse its flow direction at a combustor inlet end 164 and is channeled into combustion zones 144 and/or 148 and/or through throat region 146. Fuel is supplied into combustor assembly 102 through end cover assembly 122 and fuel nozzle assemblies 156 and/or 157. Ignition is initially achieved when a control system (not shown) initiates a starting sequence of gas turbine engine 100, and the spark plugs are then retracted from primary combustion zone 144 once a flame has been continuously established. At aft end 128, hot combustion gases 116 are channeled through transition duct 110 and turbine nozzle 106 towards turbine 104.

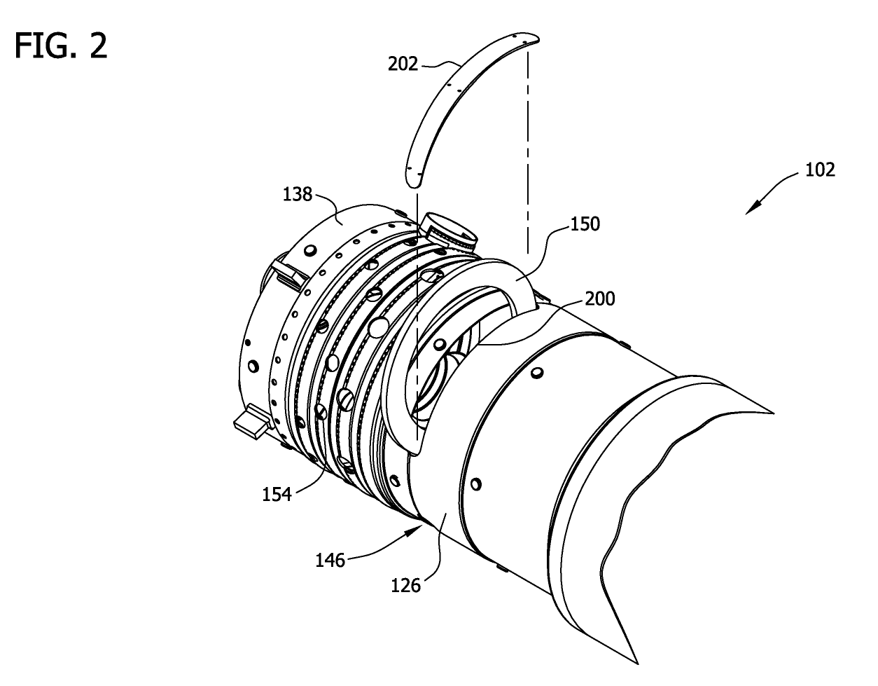

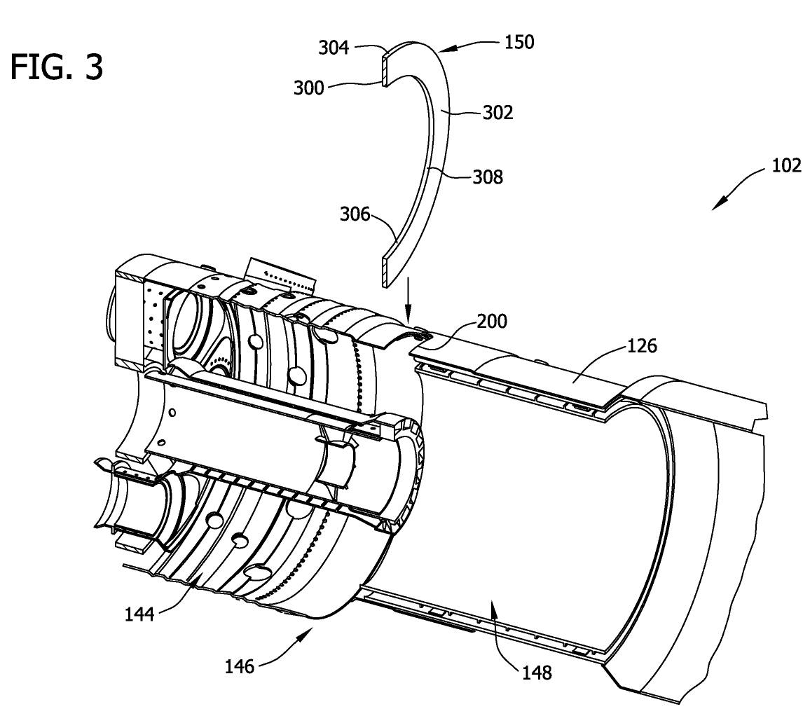

FIG. 2 is a partial perspective view of gas turbine combustor assembly 102. FIG. 3 is a partial perspective cross-sectional view of venturi throat region 146. In the exemplary embodiment, combustor assembly 102 includes a combustor liner 126 that includes a circumferential slot 200 that extends partially about combustor liner 126. Circumferential slot 200 is adjacent to venturi throat region 146. Slot 200 is sized and oriented to enable a restrictor plate 150 to be inserted through slot 200 to enable restrictor plate 150 to be position in venturi throat region 146 as described herein. In another exemplary embodiment, a cover plate 202 may be coupled to combustor liner 126 such that circumferential slot 200 is at least partially physically covered and/or sealed. Cover plate 202 may be coupled to combustor liner 126 using any number of mechanical fasteners, such as, but not limited to, rivets, screws, bolts, pins or combinations thereof. Additionally, cover plate 202 may be coupled to combustor liner 126 using any other fastening method, such as, but not limited to, welding.

In the exemplary embodiment, restrictor plate 150 includes a primary surface 300, an opposite secondary surface 302, an external surface 304, and an internal surface 306. Primary surface 300 is oriented toward primary combustion zone 144 and secondary surface 302 is oriented towards secondary combustion zone 148. External surface 304 defines a generally circular outer surface of restrictor plate 150. Outer surface 304 of restrictor plate 150 has an outside diameter that substantially matches an inner diameter of combustor liner 126. As such, internal surface 306 defines an aperture 308 in a central region of restrictor plate 150.

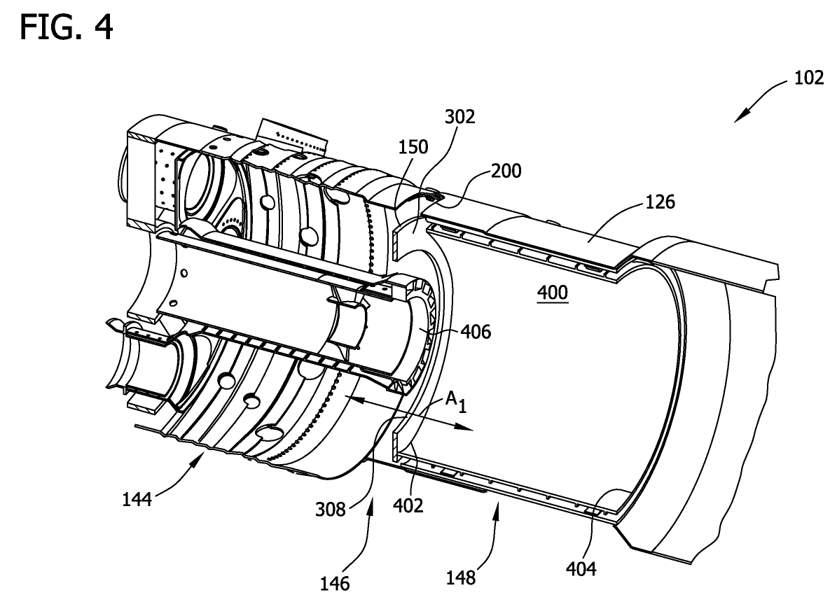

FIG. 4 is a partial perspective cross-sectional view of venturi throat region 146 including restrictor plate 150. In some embodiments, combustor assembly 102 includes a double walled liner 400 that is secured within secondary combustion zone 148. Liner 400 includes a forward end 402 and an opposite aft end 404. Restrictor plate 150 is positioned within venturi throat region 146 such that aperture 308 is aligned substantially concentrically with a diffusion tip 406. In the exemplary embodiment, restrictor plate 150 is coupled within the venturi throat region 146 as secondary surface 302 is welded to forward end 402 of liner 400, or alternatively as external surface 304 is welded to an internal surface of combustor liner 126. In another embodiment, restrictor plate 150 is coupled within venturi throat region 146 along an axial dimension Al such that a relative position of aperture 308, with respect to diffusion tip 406, can be variably adjusted, to facilitate optimizing the flame characteristics within combustor assembly 102. In such an embodiment, restrictor plate 150 may be coupled along axis Al via at least one or more spacer (not shown) to position plate 150 as desired. The spacers (not shown) may be welded between plate 150 and either combustor liner 126 or liner 400.

In operation, restrictor plate 150 is inserted through circumferential slot 200 such that aperture 308 is substantially concentrically aligned with a diffusion tip 406 of secondary fuel nozzle 157. Restrictor plate 150 provides the necessary venturi effect and functions as an aerodynamic separator or isolator to facilitate reducing flashback from secondary combustion zone 148 to primary combustion zone 144. An ignited fuel/air mixture forms a flame that flows in a downstream direction from the primary combustion zone 144 to the secondary combustion zone 148. As the flame exits the primary combustion zone 144, the flame is channeled through the reduced diameter Dᵥ in the restrictor plate 150 and then enters the secondary combustion zone 148.

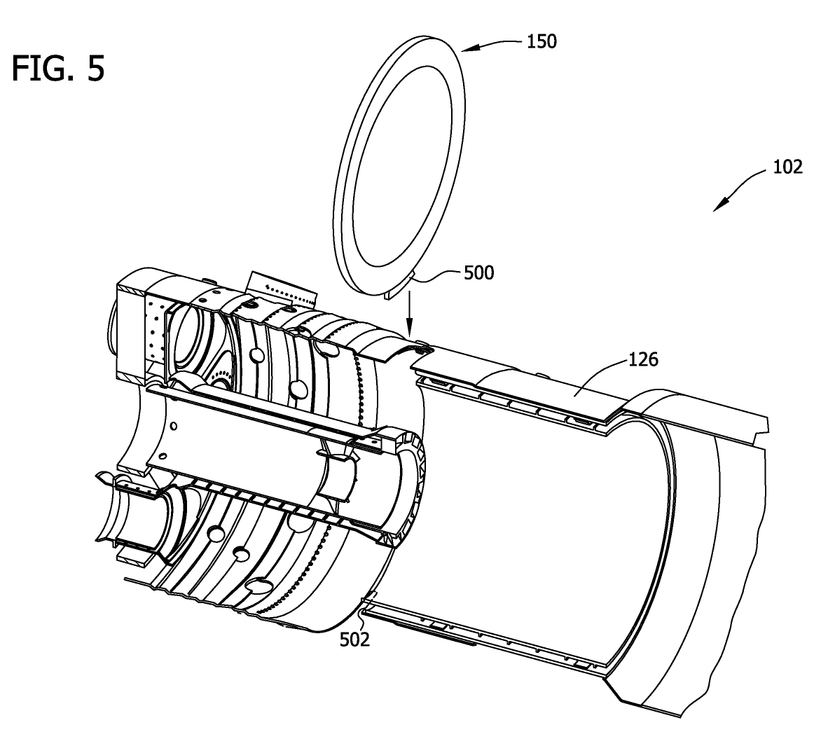

FIG. 5 is a partial perspective cross-sectional view of venturi throat region including an alternative restrictor plate 501. In the exemplary embodiment, restrictor plate 501 includes a tab 500 that extends radially outward from plate. In such an embodiment, combustor liner 126 includes a slot 502 sized and oriented to receive tab 500 therein to enable restrictor plate 150 to be coupled within combustor assembly 102. In other embodiments, restrictor plate 150 may include more than one tab 500. Tab 500 facilitates Murphy-proofing the assembly, orientation and retention of the restrictor plate 501 within the venturi throat region 146 of combustor assembly 102 by constraining the restrictor plate 501 in a particular and predefined location and orientation.

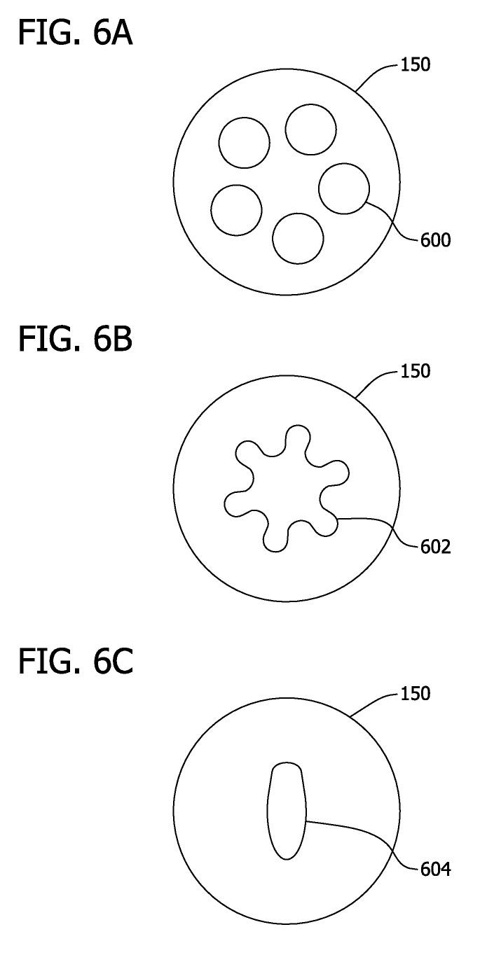

FIGS. 6A through 6C illustrate alternate embodiments for the restrictor plate 150 to include various aperture configurations. In FIG. 6A, restrictor plate 150 includes a circular array of apertures 600. FIG. 6B illustrates a star-shaped aperture 602 and FIG. 6C illustrates an oval-shaped aperture 604. Aperture configurations 600, 602 and 604 may be used to optimize the flow characteristics within combustor assembly 102. However, one of ordinary skill in the art would understand that other geometric aperture configurations may be used for flow optimization.

The above-described venturi throat region includes a removable restrictor plate that is coupled within the throat region such that flow characteristics may be optimized within the associated combustor assembly. More specifically, the venturi throat region enables the convenient removal and replacement of various restrictor plates having alternate aperture configurations. As a result, the venturi throat region may be adjusted or modified without complex maintenance and/or manufacturing expensive and complex venturi components.

Exemplary embodiments of a venturi throat region apparatus and methods for assembly of a combustor assembly are described above in detail. The apparatus and methods are not limited to the specific embodiments described herein, but rather, components of the assembly and/or steps of the method may be utilized independently and separately from other components and/or steps described herein. Further, the described assembly components and/or method steps can also be defined in, or used in combination with, other assemblies and/or methods, and are not limited to practice with only the assembly and methods as described herein.

While the invention has been described in terms of various specific embodiments, those skilled in the art will recognize that the invention can be practiced with modification within the spirit and scope of the claims.

What is claimed is:

1. A method of assembling a combustor assembly, said method comprising:
coupling a combustor liner within a gas turbine engine such that a primary combustion zone and a secondary combustion zone are defined and such that a slot at least partially circumscribing the combustor liner and defined in the combustor liner is positioned adjacent to a venturi throat region defined between the primary and the secondary combustion zones;
inserting a restrictor plate including at least one aperture defined therein, within the slot; and
coupling the restrictor plate within the combustor liner such that the restrictor plate extends at least partially across the venturi throat region to limit flow from the primary combustion zone to the secondary combustion zone.

2. A method in accordance with claim 1 wherein inserting a restrictor plate including at least one aperture further comprises inserting a restrictor plate within the slot that includes at least one of a plurality of apertures and an elliptically-shaped aperture.

3. A method in accordance with claim 1 wherein coupling the restrictor plate within the combustor liner further comprises coupling the restrictor plate to a double walled liner coupled within the combustor assembly.

4. A method in accordance with claim 1 wherein inserting a restrictor plate including at least one aperture further comprises inserting a restrictor plate including at least one tab that extends radially outward into the slot such that the at least one tab is received in a slot defined in the combustor assembly.

5. A method in accordance with claim 1 wherein inserting a restrictor plate including at least one aperture further comprises positioning the restrictor plate adjacent to a diffusion tip that is coupled within a secondary fuel nozzle.

6. A combustor assembly for use in a gas turbine engine, said combustor assembly comprising:
a combustor liner comprising a slot that at least partially circumscribes said combustor liner, said slot is defined adjacent to a venturi throat region defined within said liner; and
a restrictor plate comprising at least one aperture defined therein, said restrictor plate removably coupled within said combustor assembly such that said restrictor plate is inserted within said slot and extends at least partially across said venturi throat region.

7. A combustor assembly in accordance with claim 6 wherein said restrictor plate further comprises at least one of a plurality of apertures and an elliptically-shaped aperture.

8. A combustor assembly in accordance with claim 6 wherein said restrictor plate is coupled to a double walled liner positioned within said combustor assembly.

9. A combustor assembly in accordance with claim 6 further comprising a cover plate configured to couple to said combustor liner for substantially sealing said circumferential slot.

10. A combustor assembly in accordance with claim 6 wherein said restrictor plate further comprises at least tab that radially extends outward from an outer surface of said restrictor plate.

11. A combustor assembly in accordance with claim 10 wherein said at least one tab is inserted into at least one corresponding slot defined in said combustor assembly.

12. A combustor assembly in accordance with claim 6 wherein said restrictor plate is positioned adjacent to a diffusion tip coupled within a secondary fuel nozzle.

13. A combustor assembly in accordance with claim 6 wherein said restrictor plate is variably positionable within said venturi throat region.

14. A gas turbine engine comprising:
a compressor; and
a combustor assembly coupled downstream from said compressor, said combustor assembly comprises:
a combustor liner comprising a slot that at least partially circumscribes said combustor liner, said slot is defined adjacent to a venturi throat region defined within said combustor liner;
a restrictor plate comprising at least one aperture defined therein, said restrictor plate removably coupled within said combustor liner slot such that said restrictor plate extends at least partially across said venturi throat region.

15. A gas turbine engine in accordance with claim 14 wherein said restrictor plate further comprises at least one of a plurality of apertures and an elliptically-shaped aperture.

16. A gas turbine engine in accordance with claim 14 wherein said restrictor plate is coupled to a double walled liner coupled within said combustor assembly.

17. A gas turbine engine in accordance with claim 14 wherein said restrictor plate further comprises at least tab that radially extends outward from an outer surface of said restrictor plate.

18. A gas turbine engine in accordance with claim 17 wherein said at least one tab is inserted into at least one corresponding slot defined in said combustor assembly.

19. A gas turbine engine in accordance with claim 14 wherein said restrictor plate is positioned adjacent to a diffusion tip coupled within a secondary fuel nozzle.

20. A gas turbine engine in accordance with claim 14 wherein said restrictor plate is variably positionable within said venturi throat region.
